(19) United States
(12) Patent Application Publication
(10) Pub. No.: US 2024/0347252 A1
(43) Pub. Date: Oct. 17, 2024

(54) SPIN INDUCTOR

(71) Applicant: TDK CORPORATION, Tokyo (JP)

(72) Inventors: Tomoyuki SASAKI, Tokyo (JP); Tatsuo SHIBATA, Tokyo (JP); Katsuyuki NAKADA, Tokyo (JP)

(73) Assignee: TDK CORPORATION, Tokyo (JP)

(21) Appl. No.: 18/034,466

(22) PCT Filed: Jun. 9, 2022
(86) PCT No.: PCT/JP2022/023307

§ 371 Date: Apr. 28, 2023

(51) Int. Cl. H01F 10/32; H01F 17/00

(52) U.S. Cl. CPC H01F 10/3254; H01F 17/00

(57) ABSTRACT

A spin inductor includes a laminated body having a first inductor layer, a spacer layer, and a second inductor layer. The first inductor layer includes a first wiring layer, and a first ferromagnetic layer in contact with the first wiring layer. The second inductor layer includes a second wiring layer, and a second ferromagnetic layer in contact with the second wiring layer. The spacer layer is sandwiched between the first ferromagnetic layer and the second wiring layer.

### TECHNICAL FIELD

The present invention relates to a spin inductor.

### BACKGROUND ART

Along with resistors or capacitors, inductors are major electronic parts and are used in various types of electronic equipment. A coil is an example of the inductors. There is a trade-off relation between a size of the coil and intensity of inductance and it is difficult to achieve large inductance with a small coil.

In recent years, with the development of spintronics technology, new inductors using spins are attracting attention (for example, Non-Patent Document 1). The inductors using spins are attracting attention because the inductance intensity is increased as the element size is reduced and it is possible to achieve both miniaturization and inductance intensity.

### CITATION LIST

### Non-Patent Document

### Non-Patent Document 1

Yuta Yamane, Shunsuke Fukami, and Junichi Ieda, Physical Review Letters 128, 147201 (202).

### SUMMARY OF INVENTION

### Technical Problem

Ideally, the inductor should represent only the function of inductance, but it has an internal capacity like an internal resistance or a capacitor. A spin inductor formed of a thin film has a high resistance.

In consideration of the above-mentioned circumstance, the present invention is directed to providing a low resistance spin inductor.

### Solution to Problem

The present invention provides the following means in order to solve the above-mentioned problems.
(1) A spin inductor according to a first aspect includes a laminated body having a first inductor layer, a spacer layer, and a second inductor layer. The first inductor layer includes a first wiring layer and a first ferromagnetic layer in contact with the first wiring layer. The second inductor layer includes a second wiring layer and a second ferromagnetic layer in contact with the second wiring layer. The spacer layer is sandwiched between the first ferromagnetic layer and the second wiring layer.
(2) In the spin inductor according to the aspect, the spacer layer may be an insulator.
(3) In the spin inductor according to the aspect, the spacer layer may be a semiconductor.
(4) In the spin inductor according to the aspect, the spacer layer may contain any one selected from the group consisting of Cu, Al and Ag.
(5) In the spin inductor according to the aspect, a thickness of the spacer layer may be smaller than a thickness of the first wiring layer and the second wiring layer.
(6) In the spin inductor according to the aspect, an orientation direction of magnetization of the first ferromagnetic layer may intersect a direction of a flow direction of current flowing through the first wiring layer and a direction orthogonal to a thickness direction of the first wiring layer.
(7) In the spin inductor according to the aspect, the laminated body may have a length in a first direction that is greater than a length in a second direction perpendicular to the first direction when seen in a plan view in a thickness direction.
(8) In the spin inductor according to the aspect, the laminated body may have a meander pattern when seen in a plan view in the thickness direction.
(9) In the spin inductor according to the aspect, the laminated body may have a spiral pattern when seen in a plan view in a thickness direction.
(10) In the spin inductor according to the aspect, both a first end of the current of the laminated body in a flow direction and a second end opposite to the first end may be located outside the spiral pattern.
(11) In the spin inductor according to the aspect, both a first end of the current of the laminated body in a flow direction and a second end opposite to the first end may be located inside the spiral pattern.
(12) In the spin inductor according to the aspect, the first ferromagnetic layer and the second ferromagnetic layer may contain one or more selected from the group consisting of Cr, Mn, Co, Fe, and Ni.
(13) In the spin inductor according to the aspect, a maximum width of the laminated body when seen in a plan view in a thickness direction may be 0.003 mm or less, and an inductance may be 0.1 μH or more and 10 μH or less.
(14) In the spin inductor according to the aspect, the first ferromagnetic layer may cover a first surface of the first wiring layer as a whole.
(15) In the spin inductor according to the aspect, the first wiring layer may inject spin into the first ferromagnetic layer and cause precession of magnetization of the first ferromagnetic layer, and the second wiring layer may inject spins into the second ferromagnetic layer and cause precession of magnetization of the second ferromagnetic layer.
(16) In the spin inductor according to the aspect, the first wiring layer and the second wiring layer may contain elements having d electrons or f electrons.

### Advantageous Effects of Invention

A spin inductor according to the present invention has a low resistance.

### BRIEF DESCRIPTION OF DRAWINGS

FIG. 1 is a plan view of a spin inductor according to a first embodiment.

FIG. 2 is a cross-sectional view of a characteristic section of the spin inductor according to the first embodiment.

FIG. 3 is a plan view of a characteristic section of the spin inductor according to the first embodiment.

FIG. 4 is a schematic perspective view of a first inductor layer of the spin inductor according to the first embodiment.

FIG. 5 is a plan view of a spin inductor according to a first variant.

FIG. 6 is a plan view of a spin inductor according to a second variant.

FIG. 7 is a plan view of a spin inductor according to a third variant.

FIG. 8 is a plan view of a spin inductor according to a fourth variant.

### DESCRIPTION OF EMBODIMENTS

Hereinafter, an embodiment of the present invention will be appropriately described in detail with reference to the accompanying drawings. In the drawings used in the following description, the characteristic sections may be enlarged for convenience in order to make the characteristics easier to understand, and dimensional ratios of each component may differ from the actual ones. The materials dimensions, or the like, exemplified in the following description are examples, the present invention is not limited to them, and it is possible to change them appropriately within the scope in which the effect of the present invention is exhibited.

First, directions are defined. A direction of a surface in which each layer extends is referred to as an x direction, and a direction perpendicular to the x direction is referred to as a y direction. In addition, a thickness direction of each layer is referred to as a z direction. The z direction is perpendicular to the x direction and the y direction.

### First Embodiment

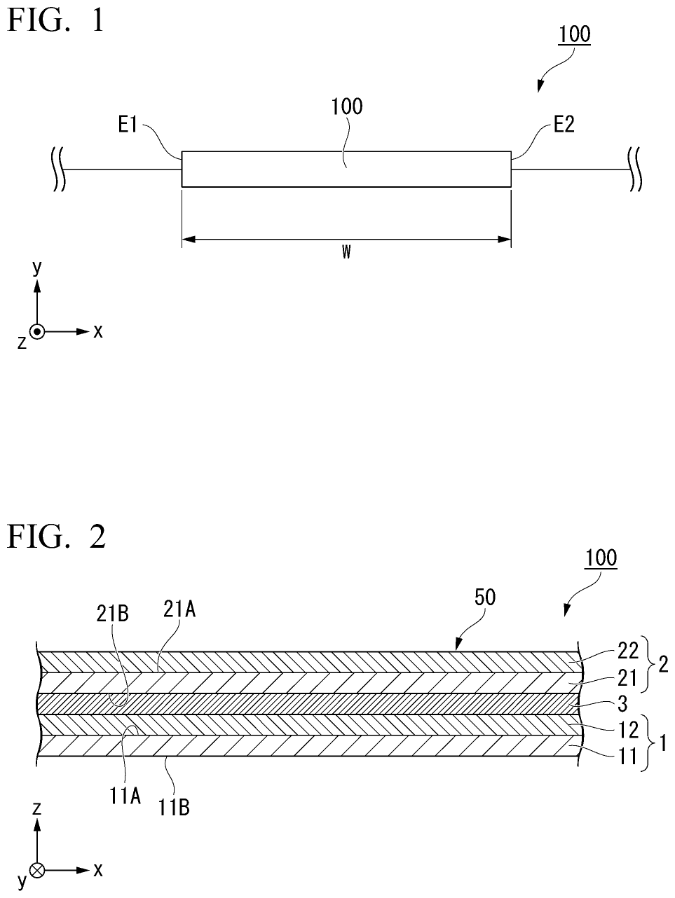

FIG. 1 is a plan view of a spin inductor 100 according to a first embodiment. The spin inductor 100 has a line shape. Current flows between a first end E1 and a second end E2 of the spin inductor 100. The spin inductor 100 cuts a high frequency component of the current and passes an invariant component of the current. The spin inductor 100 is disposed in a section where a high frequency current is to be cut. While the high frequency current is cut by the spin inductor 100, direct current flows through the spin inductor 100. For direct current, the spin inductor 100 is a resistor. A maximum width W of the spin inductor 100 is, for example, 0.003 mm or less.

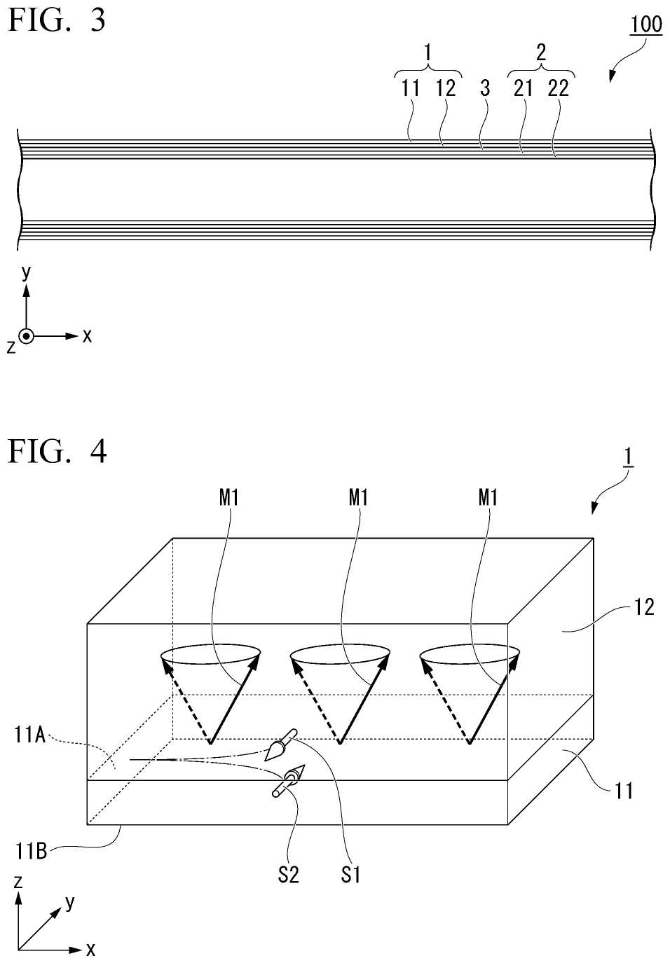

FIG. 2 is a cross-sectional view of a characteristic section of the spin inductor 100 according to the first embodiment. FIG. 3 is a plan view of a characteristic section of the spin inductor 100 according to the first embodiment.

The spin inductor 100 includes a laminated body 50. The laminated body 50 has a line shape in which a length in a first direction is greater than a length in a second direction. The first direction coincides with, for example, the x direction. The second direction coincides with, for example, the y direction. In the laminated body 50, the length in the x direction is greater than the length in the y direction.

The laminated body 50 includes a first inductor layer 1, a second inductor layer 2, and a spacer layer 3. Here, while the case in which the inductor layer is constituted by two layers is exemplified, the number of the inductor layers may be two layers or more. The spacer layer is sandwiched between the adjacent inductor layers.

The first inductor layer 1 includes a first wiring layer 11 and a first ferromagnetic layer 12. The second inductor layer 2 includes a second wiring layer 21 and a second ferromagnetic layer 22. Even when there are two or more layers of inductor layers, each of the inductor layers includes a wiring layer and a ferromagnetic layer.

Each of the first wiring layer 11 and the second wiring layer 21 includes any one of a metal, alloy, intermetallic compound, metal boride, metal carbide, metal silicate, and metal phosphide having a function of generating spin current using a spin Hall effect when current flows. The first wiring layer 11 and the second wiring layer 21 are referred to as spin-orbit-torque wirings.

Each of the first wiring layer 11 and the second wiring layer 21 includes, for example, a non-magnetic heavy metal as a main component. The heavy metal means a metal having a specific weight greater than that of yttrium (Y). The non-magnetic heavy metal is a non-magnetic metal having an atomic number greater than an atomic number of 39 having, for example, d electrons or f electrons in the outermost shell. Each of the first wiring layer 11 and the second wiring layer 21 is formed of, for example, Hf, Ta or W. The non-magnetic heavy metal causes stronger spin-orbit interaction than other metals. A spin Hall effect is generated by the spin-orbit interaction, spins tend to be unevenly distributed in the wiring layer, and spin current J_{S} tends to occur.

Each of the first wiring layer 11 and the second wiring layer 21 may additionally include a magnetic metal. The magnetic metal is a ferromagnetic metal or an antiferromagnetic metal. A small amount of magnetic metal contained in the non-magnetic body becomes a cause of spin scattering. The small amount is, for example, 3% or less for a total molar ratio of an element that constitutes the wiring layer. When the spins are scattered by the magnetic metal, the spin-orbit interaction is enhanced, and generation efficiency of the spin current with respect to the current is increased.

Each of the first wiring layer 11 and the second wiring layer 21 may include a topological insulator. The topological insulator is a material whose interior is an insulator or a high resistance body, but whose surface has a spin-polarized metallic state. The topological insulator produces an internal magnetic field using the spin-orbit interaction. The topological insulator develops a new topological phase due to the effect of the spin-orbit interaction even when there is no external magnetic field. The topological insulator can generate a pure spin current with high efficiency using the strong spin-orbit interaction and breaking of inversion symmetry at the edge.

The topological insulator is, for example, Sn, SnTe, Bi_{1.5}Sb_{0.5}Te_{1.7}Se_{1.3}, TlBiSe₂, Bi₂Te₃, Bi₁₋ₓSbₓ, (Bi₁₋ₓSbₓ)₂Te₃, or the like. The topological insulator can generate a spin current with high efficiency.

The first wiring layer 11 generates a spin current using a spin Hall effect when the current flows, and injects spins into the first ferromagnetic layer 12. The second wiring layer 21 generates a spin current using a spin Hall effect when the current flows, and injects spins into the second ferromagnetic layer 22. FIG. 4 is a schematic view of movement of magnetization M1 and spins S1 and S2 in the first inductor layer 1.

The spin Hall effect is a phenomenon in which a spin current is induced in a direction (for example, the z direction) perpendicular to the direction in which the current flows based on the spin-orbit interaction when the current flows. The spin Hall effect is similar to a normal Hall effect in that moving (shifting) electric charges (electrons) bend a moving (shifting) direction. In the normal Hall effect, the moving direction of the charged particles moving in the magnetic field is bent by the Lorentz force. On the other hand, in the spin Hall effect, even when there is no magnetic field, the moving direction of the spins is bent by shifting the electron (just flowing the current).

For example, when the current flows in the x direction of the first wiring layer 11, for example, the spin S1 polarized in a-y direction is bent in a +z direction, and the spin S2 polarized in a ty direction is bent in a-z direction. The spin S1 is concentrated on a first surface 11A, and the spin S2 is concentrated on a second surface 11B. The spins accumulated on the first surface 11A or the second surface 11B are injected into the adjacent layers. That is, the spin S1 is injected into the first ferromagnetic layer 12 from the first surface 11A of the first wiring layer 11. By the same principle, when the current flows in the x direction of the second wiring layer 21, the spins are injected into the second ferromagnetic layer 22 from the second wiring layer 21.

The first ferromagnetic layer 12 comes into contact with the first surface 11A of the first wiring layer 11. The first ferromagnetic layer 12 covers the first surface 11A of the first wiring layer 11 as a whole, for example, when seen in the z direction. The second ferromagnetic layer 22 comes into contact with a first surface 21A of the second wiring layer 21. The second ferromagnetic layer 22 covers the first surface 21A of the second wiring layer 21 as a whole, for example, when seen in the z direction.

The first ferromagnetic layer 12 and the second ferromagnetic layer 22 are ferromagnetic bodies. The ferromagnetic body is, for example, a metal selected from the group consisting of Cr, Mn, Co, Fe and Ni, an alloy containing one or more of these metals, an alloy containing at least one or more elements of these metals, B, C, and N, or the like. The ferromagnetic body is, for example, Co—Fe, Co—Fe—B, Ni—Fe, Co—Ho alloy, Sm—Fe alloy, Fe—Pt alloy, Co—Pt alloy, or CoCrPt alloy. The CoCrPt alloy and L1₀ type CoFe alloy have large saturated magnetization and strong magnetic anisotropy, and when these are used in the first ferromagnetic layer 12 and the second ferromagnetic layer 22, a resonance frequency of the spin inductor 100 is increased. Since the spin inductor 100 generates a resonance phenomenon at a ferromagnetic resonance frequency of the first ferromagnetic layer 12 and the second ferromagnetic layer 22, it is difficult to stably operate the inductor in the vicinity of the resonance frequency. Accordingly, the spin inductor 100 is used at a frequency substantially lower or substantially higher than the ferromagnetic resonance frequency of the spin inductor 100. The substantially low frequency or the substantially high frequency indicates a frequency deviated about 5% or more of the ferromagnetic resonance frequency with reference to the ferromagnetic resonance frequency.

The first ferromagnetic layer 12 has the magnetization M1. The second ferromagnetic layer 22 has magnetization. The magnetization M1 of the first ferromagnetic layer 12 is precessed by the spin S1 injected from the first wiring layer 11. The magnetization of the second ferromagnetic layer 22 is precessed by the spins injected from the second wiring layer 21.

The magnetization M1 of the first ferromagnetic layer 12 is preferably oriented in a direction crossing a direction (for example, the y direction) perpendicular to the flow direction (for example, the x direction) of the current flowing through the first wiring layer 11 and the thickness direction (for example, the z direction) of the first wiring layer 11 in an initial state. The initial state is a state in which no current flows in the wiring layer and no external magnetic field is applied. The magnetization M1 of the first ferromagnetic layer 12 may be oriented in the flow direction (for example, the x direction) of the current flowing through the first wiring layer 11 or the thickness direction (for example, the z direction) of the first wiring layer 11 in the initial state.

The magnetization of the second ferromagnetic layer 22 is preferably oriented in a direction crossing a direction (for example, the y direction) perpendicular to the flow direction (for example, the x direction) of the current flowing through the second wiring layer 21 and the thickness direction (for example, the z direction) of the second wiring layer 21 in the initial state. The magnetization of the second ferromagnetic layer 22 may be oriented in the flow direction (for example, the x direction) of the current flowing through the second wiring layer 21 or the thickness direction (for example, the z direction) of the second wiring layer 21 in the initial state.

When the magnetization of the ferromagnetic layer is oriented in the direction (for example, the y direction) perpendicular to the flow direction (for example, the x direction) of the current and the thickness direction (for example, the z direction) of the layer, magnetization reversal may occur even in a state in which no external magnetic field is applied. When the magnetization reversal occurs, precession of the magnetization is not maintained. Since the spin inductor 100 exhibits the inductor function using energy conversion between the magnetic moment and the current, when the precession of the magnetization is stopped, the inductor function is not sufficiently exhibited.

Further, even when the magnetization of the ferromagnetic layer is oriented in the direction (for example, the y direction) perpendicular to the flow direction (for example, the x direction) of the current and the thickness direction (for example, the z direction) of the layer, it is possible to maintain the precession of the magnetization by adjusting a density of the current flowing through the wiring layer.

The spacer layer 3 is disposed between the first inductor layer 1 and the second inductor layer 2. When the inductor layers are two layers or more, the spacer layer 3 is disposed between the adjacent inductor layers. For example, the spacer layer 3 is disposed between the first ferromagnetic layer 12 and the second wiring layer 21. The spacer layer 3 may be located at a position where the second surface 11B of the first wiring layer 11 comes into contact therewith.

The spacer layer 3 breaks symmetry of the second wiring layer 21 in the z direction. The second ferromagnetic layer 22 in contact with the first surface 21A of the second wiring layer 21 is different from the spacer layer 3 in contact with a second surface 21B. For example, the second ferromagnetic layer 22 in contact with the first surface 21A and the spacer layer 3 in contact with the second surface 21B are different in any one of a crystal structure, a composition, and a material. When the layers in contact with the first surface 21A and the second surface 21B of the second wiring layer 21 are different, symmetry of the second wiring layer 21 in the z direction is broken. When the symmetry of the second wiring layer 21 is broken, an amount of spins injected into the second ferromagnetic layer 22 from the second wiring layer 21 is increased.

The spacer layer 3 includes a non-magnetic body. The spacer layer 3 may be, for example, an insulator. The spacer layer 3 may use, for example, Al₂O₃, SiO₂, MgO, MgAl₂O₄, and the like. In addition, in addition to these, a material obtained by substituting some of Al, Si and Mg with Zn, Be, or the like, may be used.

When the spacer layer 3 is the insulator, it is possible to suppress the spins from being injected into the first ferromagnetic layer 12 from the second wiring layer 21. The polarization direction of the spins injected into the first ferromagnetic layer 12 from the second wiring layer 21 is opposite to the polarization direction of the spins injected into the first ferromagnetic layer 12 from the first wiring layer 11, which causes disturbance in the precession of the magnetization M1 of the first ferromagnetic layer 12. In addition, when the spacer layer 3 is the insulator, no current flows through the spacer layer 3, the amount of the current flowing through the first wiring layer 11 and the second wiring layer 21 can be increased, and inductance of the spin inductor 100 can be increased.

The spacer layer 3 may be, for example, a semiconductor. The semiconductor is, for example, Si, Ge, CuInSe₂, CuGaSe₂, Cu(In,Ga)Se₂, or the like.

When the spacer layer 3 is the semiconductor, capacitance between the first inductor layer 1 and the second inductor layer 2 can be reduced. When the capacitance is small, even though a high frequency current is applied, the spin inductor 100 can exhibit the function of the inductor.

The spacer layer 3 may be, for example, a conductor. The spacer layer 3 may contain, for example, any one of selected from the group consisting of Cu, Al and Ag. The spacer layer 3 may be, for example, any one of Cu, Al and Ag. When the spacer layer 3 is the conductor, the resistance of the entire spin inductor 100 can be lowered. In addition, when the spacer layer 3 is the conductor, the capacitance between the first inductor layer 1 and the second inductor layer 2 is reduced.

A film thickness of the spacer layer 3 is smaller than, for example, the thickness of each of the first wiring layer 11 and the second wiring layer 21. By reducing the film thickness of the spacer layer 3, it is possible to prevent a large amount of current from flowing to the spacer layer 3 and to increase the inductance of the spin inductor 100.

The spin inductor 100 according to the first embodiment exhibits the function as the inductor by performing precession of the magnetization of the ferromagnetic layer using the spins injected from the wiring layer. In addition, the spin inductor 100 has a plurality of parallel routes between the first end E1 and the second end E2 of the spin inductor 100 by providing the plurality of inductor layers, and the resistance of the spin inductor 100 is low. In addition, since the spacer layer 3 breaks symmetry of the wiring layer in the z direction, the spin inductor 100 can increase the amount of the spins injected into the ferromagnetic layer from the wiring layer.

In addition, since the spin inductor according to the first embodiment exhibits the inductor function using energy conversion between the current and the magnetic moment, it is possible to exhibit the strong inductance even when the spin inductor is small. For example, even when the maximum width of the laminated body 50 when seen in a plan view in the z direction is 0.003 mm or less, it is possible to exhibit the inductance of 0.1 μH or more and 10 μH or less.

So far, while the example of the first embodiment has been shown, the present invention is not limited to these embodiments, and various variants are possible.

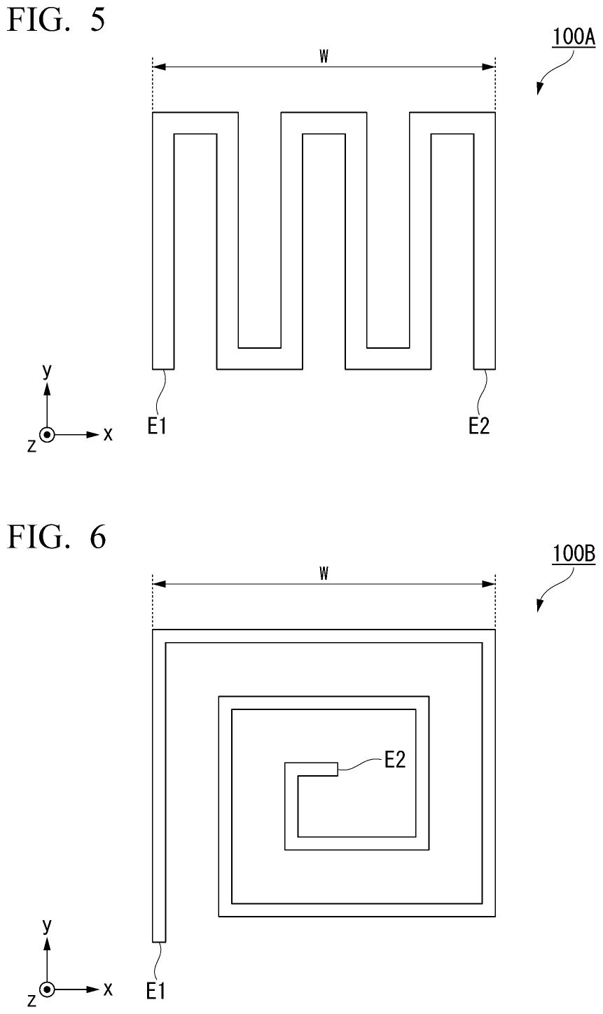

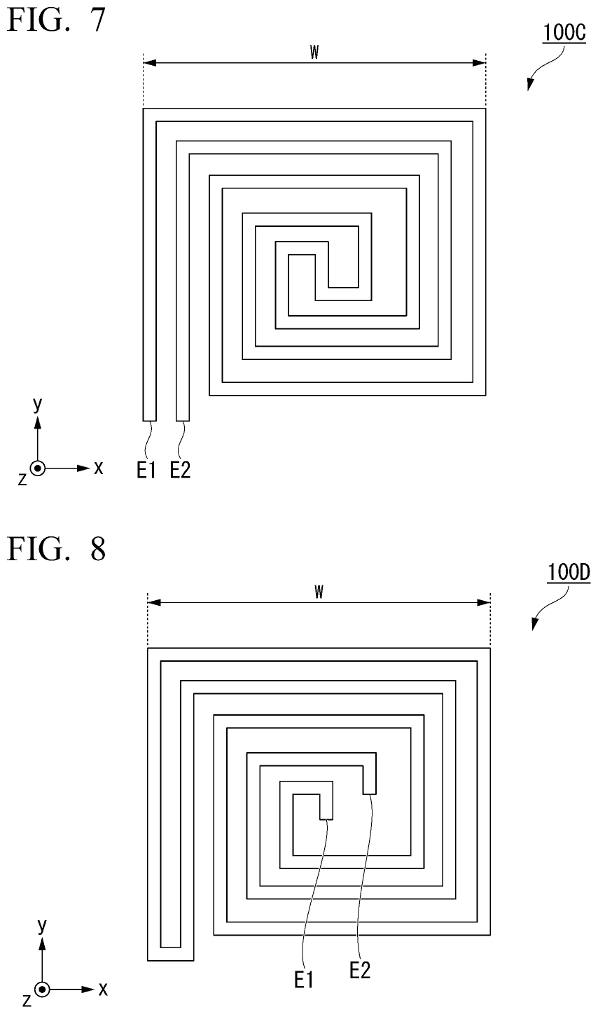

For example, while the case in which the spin inductor 100 seen in the z direction has a line shape when seen in a plan view has been shown in FIG. 1, it is not limited to the example. For example, like a spin inductor 100A shown in FIG. 5, a shape when seen in a plan view in the z direction may be a meander pattern, and like spin inductors 100B to 100D shown in FIG. 6 to FIG. 8, a shape when seen in a plan view in the z direction may be a spiral pattern. In addition, like the spin inductors 100B to 100D shown in FIG. 6 to FIG. 8, the first end E1 and the second end E2 may be provided inside or outside the spiral pattern.

### REFERENCE SIGNS LIST

1 First inductor layer
2 Second inductor layer
3 Spacer layer
11 First wiring layer
12 First ferromagnetic layer
12 Second wiring layer
22 Second ferromagnetic layer
11A, 21A First surface
11B, 21B Second surface
50 Laminated body
100, 100A, 100B, 100C, 100D Spin inductor
E1 First end
E2 Second end

1. A spin inductor comprising a laminated body having a first inductor layer, a spacer layer, and a second inductor layer,
wherein the first inductor layer includes a first wiring layer and a first ferromagnetic layer in contact with the first wiring layer,
the second inductor layer includes a second wiring layer and a second ferromagnetic layer in contact with the second wiring layer, and
the spacer layer is sandwiched between the first ferromagnetic layer and the second wiring layer.

2. The spin inductor according to claim 1, wherein the spacer layer is an insulator.

3. The spin inductor according to claim 1, wherein the spacer layer is a semiconductor.

4. The spin inductor according to claim 1, wherein the spacer layer contains any one selected from the group consisting of Cu, Al and Ag.

5. The spin inductor according to claim 4, wherein a thickness of the spacer layer is smaller than a thickness of the first wiring layer and the second wiring layer.

6. The spin inductor according to claim 1, wherein an orientation direction of magnetization of the first ferromagnetic layer intersects a direction of a flow direction of current flowing through the first wiring layer and a direction orthogonal to a thickness direction of the first wiring layer.

7. The spin inductor according to claim 1, wherein the laminated body has a length in a first direction that is greater than a length in a second direction perpendicular to the first direction when seen in a plan view in a thickness direction.

8. The spin inductor according to claim 1, wherein the laminated body has a meander pattern when seen in a plan view in a thickness direction.

9. The spin inductor according to claim 1, wherein the laminated body has a spiral pattern when seen in a plan view in a thickness direction.

10. The spin inductor according to claim 9, wherein both a first end of the current of the laminated body in a flow direction and a second end opposite to the first end are located outside the spiral pattern.

11. The spin inductor according to claim 9, wherein both a first end of the current of the laminated body in a flow direction and a second end opposite to the first end are located inside the spiral pattern.

12. The spin inductor according to claim 1, wherein the first ferromagnetic layer and the second ferromagnetic layer contain one or more selected from the group consisting of Cr, Mn, Co, Fe, and Ni.

13. The spin inductor according to claim 1, wherein a maximum width of the laminated body when seen in a plan view in a thickness direction is 0.003 mm or less, and
an inductance is 0.1 μH or more and 10 μH or less.

14. The spin inductor according to claim 1, wherein the first ferromagnetic layer covers a first surface of the first wiring layer as a whole.

15. The spin inductor according to claim 1, wherein the first wiring layer injects spins into the first ferromagnetic layer and causes precession of magnetization of the first ferromagnetic layer, and
the second wiring layer injects spins into the second ferromagnetic layer and causes precession of the magnetization of the second ferromagnetic layer.

16. The spin inductor according to claim 1, wherein the first wiring layer and the second wiring layer contain elements having d electrons or f electrons.
